(19) United States
(12) Patent Application Publication
(10) Pub. No.: US 2023/0408339 A1
(43) Pub. Date: Dec. 21, 2023

(54) WRITING UTENSIL, LIGHT DETECTION SYSTEM AND METHOD FOR DETERMINING A LIGHT CONDITION

(71) Applicant: ams Sensors Germany GmbH, Jena (DE)

(72) Inventors: Gunter SIESS, Kraftsdorf (DE); Fred GRUNERT, Bad Klosterlausnitz (DE); David GAMPERL, HARTBERG (AT); Frank KRUMBEIN, Erfurt (DE)

(73) Assignee: ams Sensors Germany GmbH, Jena (DE)

(21) Appl. No.: 18/250,628

(22) PCT Filed: Oct. 29, 2021
(86) PCT No.: PCT/EP2021/080192

§ 371 Date: Apr. 26, 2023

(30) Foreign Application Priority Data
Oct. 30, 2020 (DE) 102020128631.7

(51) Int. Cl. G01J 3/50; G01J 3/02; G01J 1/42; G01J 1/02; B43K 29/08

(52) U.S. Cl. CPC G01J 3/50; G01J 3/0275; G01J 1/4204; G01J 1/0233; G01J 3/0272; B43K 29/08

(57) ABSTRACT

A writing utensil including a color sensor operable to generate sensor data A processing unit is configured to receive the sensor data from the color sensor and to output the sensor data. A networking device is configured to receive the sensor data from the processing unit and arranged to transmit the sensor data via a network connection.

### CROSS-REFERENCE TO RELATED APPLICATIONS

The present application is the national stage entry of International Patent Application No. PCT/EP2021/080192, filed on Oct. 29, 2021, and published as WO 2022/090504 A1 on May 5, 2022, which claims the benefit of priority of German Patent Application No. 10 2020 128 631.7, filed on Oct. 30, 2020, the disclosures of all of which are incorporated by reference herein in their entireties.

### FIELD OF DISCLOSURE

This disclosure relates to a writing utensil, light detection system and method for determining a light condition.

### BACKGROUND

Knowing a light condition can be beneficial for many types for applications. For example, for correct ambient white balancing, AWB, of camera images it is necessary to know the illumination, e.g. correlate color temperature, CCT, or spectra, which illuminates a taken scene. A camera or a mobile device with imaging capabilities often has an integrated ambient light sensor. However, this sensor has a fixed setup in the device and the field of view, FOV, is mostly directed to the scene. Depending on the setup, while taking a photo, contributions of parts influencing the ambient light of the scene from other directions may not be accurately detected. In traditional photography this is solved by an external accessory, such as a dedicated photometer for ambient light sensing, ALS, to measure a more real ambient light or ambient light distribution which influences the color of the scene and perform a perfect ambient white balancing of an image. However, such an accessory is specialized and expensive equipment. Typically, such equipment is only available for professional photography gear rather than consumer grade mobile devices.

It is an object of the present disclosure to provide a writing utensil, a light detection system and a method for determining a light condition which overcome the shortcomings of the art.

These objectives are achieved by the subject matter of the independent claims. Further developments and embodiments are described in the dependent claims.

It is to be understood that any feature described in relation to any one embodiment may be used alone, or in combination with other features described herein, and may be used in combination with one or more features of any other of the embodiments, or any combination of any other of the embodiments unless described as an alternative. Furthermore, equivalents and modifications not described below may also be employed without departing from the scope of the display, display device and method to operate a display which are defined in the accompanying claims.

### SUMMARY

The following relates to an improved concept in the field of light condition detection. A writing utensil is proposed which at least comprises a color sensor, a processing unit and a networking device. The processing unit is configured to receive sensor signals from the color sensor and to provide sensor data to the networking device. The networking device is configured to transmit the data, e.g. to a host system with an image sensor.

For example, ALS can be implemented in the rear of the writing utensil such as a stylus or smart pen. This can be a hard end of a pen or the pen button. Ambient light conditions can be measured before taking a photo, e.g. as reference measurement, and transmit sensor data via a side push button as trigger to the camera/phone and visualize the detected color and spectral information on the display (e.g. CCT, CRI, type of light). In addition, an ambient condition can be measured by synchronous measurement of the image sensor in the host system, e.g. the side push button can be used to remotely trigger image acquisition by the host system. Data of ALS can be used for real time ambient white balance, AWB, and also for saving this information to an image data header for post processing.

There are different possible ways of how to use the writing utensil for light detection and other applications. The pen can be directed to a light source and transmit (spectral) sensor data to the imaging device, e.g. by pressing the side button. Spectra are analyzed and calculation yields parameters such as CCT, CRI, type of light, quality light sources, which may be visualized on the imaging device. Other applications may include controlling of multicolor LED light sources by using sensor data and analyze spectra of the LED types and mixing for a first lamp and then prepare regulation of the performance of a second multi LED lamp until the colors match. The writing utensil allows for dynamic measurement and transmitting by moving the pen to several directions and monitor the movement of the pen (e.g. viewing direction) by the data of acceleration and rotation sensors to create a more dimensional radiation map.

Hereinafter, a digital pen, or smart pen, is an input device which captures the handwriting or brush strokes of a user and converts handwritten analog information created using “pen and paper” into digital data, enabling the data to be utilized in various applications.

In at least one embodiment a writing utensil comprises a color sensor, a processing unit and a networking device. The color sensor is operable to generate sensor data. The processing unit is configured to receive the sensor data from the color sensor and to output the sensor data. The networking device is configured to receive the sensor data from the processing unit and is further arranged to transmit the sensor data via a network connection.

In at least one embodiment the color sensor comprises a multispectral sensor. Alternatively, or in addition, the color sensor comprises an ambient light sensor. In at least one embodiment the processing unit is configured to determine a light condition based on a comparison of predefined spectral data to sensor data corresponding to an output of the multispectral sensor.

In at least one embodiment the light condition involves an ambient light source classification for adjusting a color balance, a correlated color temperature, a color rendering index, a type of light source and/or an output of a multicolor light source such as an LED.

In at least one embodiment the writing utensil comprises a handheld housing and the color sensor is arranged at an end section of the handheld housing.

In at least one embodiment the end section comprises a cavity. The color sensor is arranged in the cavity.

In at least one embodiment a push button is connected to the end section. The color sensor is arranged in a cavity of the end section or in a cavity of the push button.

In at least one embodiment the writing utensil comprises a switch which is operable to control at least one of the following operations: an acquisition of sensor data by means of the color sensor, a processing of sensor data by means of the processing unit and/or a transmission of sensor data by means of the networking device.

In at least one embodiment a light detection system comprises a writing utensil according to one of the aspects discussed above and an imaging device. The imaging device comprises a receiver which is operable to receive sensor data transmitted by the networking device.

In at least one embodiment a method for determining a light condition comprises the following steps. First, sensor data is generated using a color sensor which is arranged in a writing utensil. The sensor data is then processed by means of a processing unit and transmitted via a network to a receiver by means of a networking device.

The following description of figures of example embodiments may further illustrate and explain aspects of the improved concept. Components and parts with the same structure and the same effect, respectively, appear with equivalent reference symbols. Insofar as components and parts correspond to one another in terms of their function in different figures, the description thereof is not necessarily repeated for each of the following figures.

### BRIEF DESCRIPTION OF THE DRAWINGS

In the Figures:

FIG. 1 shows an example embodiment of a writing utensil, and

FIGS. 2A to 2F show example embodiments of an end section of the writing utensil.

### DETAILED DESCRIPTION

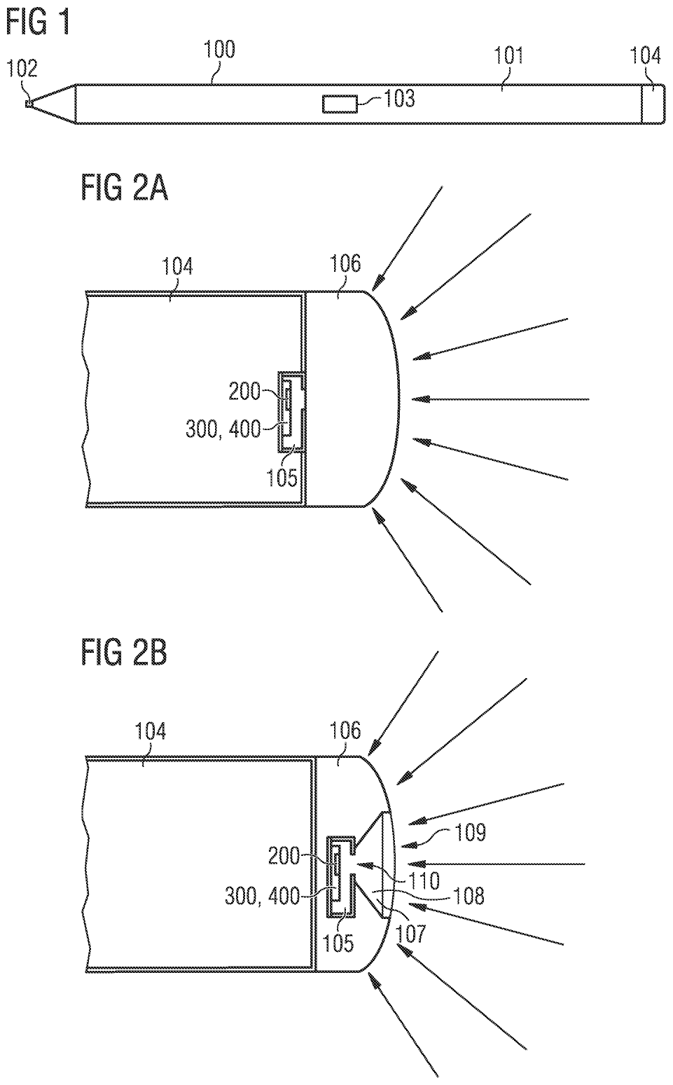

FIG. 1 shows an example embodiment of a writing utensil. The writing utensil in this embodiment is arranged as a digital pen 100, or Smart-Pen. The pen comprises further electronic components including a color sensor 200, a processing unit 300 and a networking device 400.

The pen 100 comprises a handheld housing 101 composed of metal, plastic, glass, or other suitable material. The further electronic components, i.e. color sensor 200, processing unit 300 and networking device 400 are embedded in the handheld housing. For example, the color sensor 200, processing unit 300 and networking device 400 are integrated into a common sensor package, and the sensor package is embedded in the handheld housing. At one end the housing comprises a tip 102 which is operable of writing on a surface. The tip 102 may be “digital” in the sense that it is arranged to convert handwritten analog information, created by moving the pen, into digital information. However, the tip may also be “analog” in the sense that it is designed to apply substances on a writing surface such as paper, for example. Examples include a fountain tip or ball-point tip, felt tip, or any other applicator designed to apply a liquid, such as ink or other material, to a surface.

The color sensor 200 comprises a multispectral sensor 201. The multispectral sensor is operable to sense wavelengths of radiation spanning at least a portion of the visible light spectrum. For example, the multispectral sensor comprises multi-channels, e.g. optical channels distributed over the visible range. In general, the multi-channels may cover a spectral response defined by wavelengths of radiation in the range of approximately 350 nm to 1000 nm, e.g. a main range for ambient detection may comprise the visual, VIS, spectral range from 380 nm to 780 nm, or more practical 400 nm to 700 nm. The color sensor may also extend into infrared, IR, or near infrared, NIR, i.e. 780 to 1400 nm or into the ultraviolet, UV, with wavelengths smaller than 380 nm.

Alternatively, or in addition, the color sensor 200 comprises an ambient light sensor, ALS. This type of sensor may have as few as a single channel and is operable to provide measurements of ambient light intensity, e.g. which match the human eye's response to light under a variety of lighting conditions. The ambient light sensor may have multi-channels, e.g. RGB, which have spectral response in the range of approximately 350 nm to 1000 nm, e.g. a main range for ambient detection may comprise the visual, VIS, spectral range from 380 nm to 780 nm, or more practical 400 nm to 700 nm. The color sensor may also extend into infrared, IR, or near infrared, NIR, i.e. 780 to 1400 nm or into the ultraviolet, UV, with wavelengths smaller than 380 nm. In some embodiments of a multi-channel ambient light sensor, the sensor provides spectral information, e.g. a sensor signal which corresponds to an integrated response, e.g. scotopic or photopic intensity, integrated over the multi-channels, for example.

The processing unit 300 is communicably coupled to the color sensor 200. The processor unit 300 comprises one or more processors and/or microcontrollers and/or microprocessors, for example. Depending on the actual implementation the processing unit takes over different tasks. For example, the processing unit controls data acquisition by means of the color sensor. Furthermore, the processing unit receives sensor data from the color sensor and conducts pre-processing steps on said data. The pre-processing involves forwarding the sensor data to the networking device, for example. The pre-processing, however, may involve more sophisticated steps for determining a light condition from the sensor data, as will be discussed in further detail below. The processing unit may be operable to conduct parts, if not all steps, of a method for determining a light condition.

The networking device 400 is operable to receive sensor data and transmit the data to a receiver (not shown). The receiver may be part of a light detection system such as an imaging system or a display system, e.g. including a mobile phone, a camera, an image-recording device and/or a video recording device or any system which may use ambient information to conduct light control, such as automatic white balancing or dimming of a display. The networking device may provide a network, or be part of a network provided by the receiver, to transmit the data. For example, the network may be a Wireless Local Area Network and/or Bluetooth.

The housing 101 comprises a switch 103. The switch is operable to control the processing unit. For example, by user activation the switch may initiate data acquisition by means of the color sensor. Furthermore, by pressing the switch, or by pressing the switch in a defined sequence, the processing unit can be controlled, e.g. to initiate forwarding the sensor data to the networking device and/or initiating transmission of the sensor data.

The housing 101 has an end section 104, which is arranged opposite of the tip 102 (as seen along the main axis of the pen). The end section 104 may be implemented as a fixed end or as a push button, for example. In a fixed end implementation, the end section may have no further active function. However, in the push button implementation, the end section can be used for additional functionality. For example, the push button may have the switch 103, and, thus, may be used to control operation of the pen. However, the push button may be different to switch 103 and, thus, may be used for other functionality, such as control of additional sensors or control a writing property of the pen, like activating/deactivating writing, changing of color or linewidth, etc.

Basically, the color sensor 200, or a sensor package comprising the color sensor, can be implemented anywhere in the housing 101. However, the end section may provide a field of view of which typically is not obstructed by a user's hand and could be directed to a target, such as a light source to be determined or the receiver. This way the pen can be used for determining a light condition.

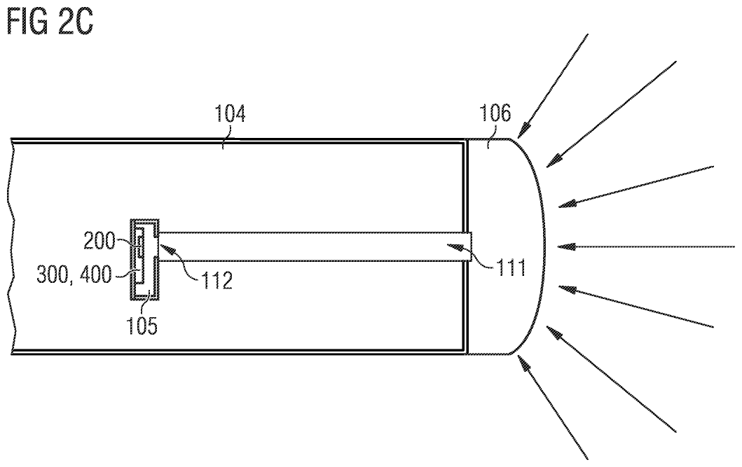

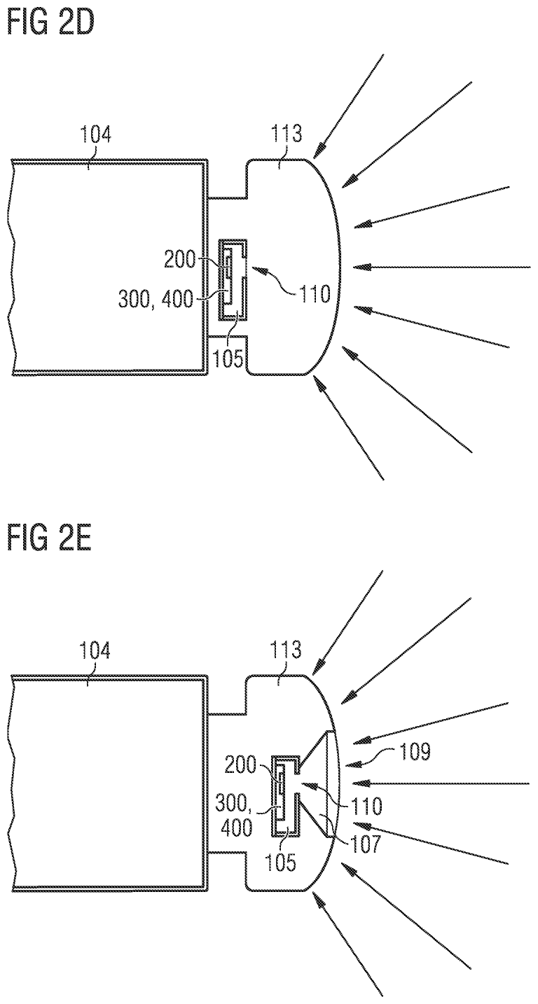

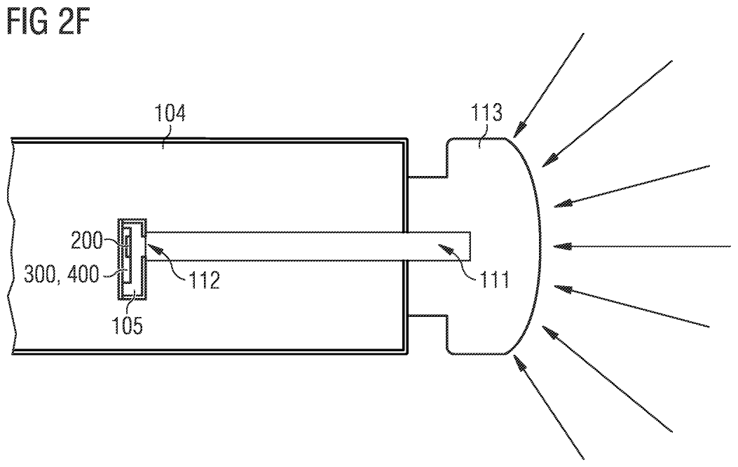

FIGS. 2A to 2F show example embodiments of an end section of the writing utensil. The drawings show cross-sections of the end section 104.

FIG. 2A shows an embodiment where the color sensor is integrated into a cavity 105 which is arranged at the end section 104. A cap 106 is connected to the end section 104 and covers the cavity 105. This way the color sensor 200, which is arranged in the cavity 105, is sealed from the ambient. The cap 106 comprises a translucent material. The cap has the effect to couple light towards the color sensor. For example, the cap material is arranged as a diffuser which directs light from various directions towards the color sensor. This implementation can be considered a direct coupling design of color sensor to the cap.

FIG. 2B shows another embodiment wherein the color sensor is integrated into a cavity 105. In this implementation the cap 106 comprises the cavity 105 and is connected to the end section 104. The cap 106 may be composed of an opaque material. The cap material may be the same as the housing, e.g. be composed of metal, plastic, glass, or other suitable material.

The cap 106 further comprises a funnel 107 which, via its base 108, is connected to the cavity 105. An arc 109 of translucent material is arranged in an aperture 110 of the funnel. The arc 109 constitutes an optical window which allows light to enter the funnel and be directed towards the color sensor. For example, the arc material is arranged as a diffuser which directs light from various directions towards the color sensor.

FIG. 2C shows an embodiment where the color sensor is integrated into a cavity 105 arranged at the end section 104. Similar, to the embodiment of FIG. 2A, the cap 106 is connected to the end section 104. However, a light guide 111 is arranged in the end section and connects the cavity 105 with the cap. The cap covers an opening 112 of the light guide. This way the color sensor 200, arranged in the cavity 105, is sealed from the ambient. The cap 106 comprises an optically translucent material. The cap has the effect to couple light towards the color sensor. For example, the cap material is arranged as a diffuser which directs light from various directions towards the color sensor. This implementation can be considered an indirect coupling design of color sensor to the cap. The light guide effectively brings the color sensor deep inside the pen and thereby provides improved stability.

FIG. 2D shows another embodiment where the color sensor is integrated into a cavity 105. In this implementation a push button 113 comprises the cavity 105 and is connected to the end section 104. The drawing shows a cross-section of the push button. The push button comprises an opaque or translucent material which encloses the cavity 105 completely. This way the color sensor 200, arranged in the cavity 105, is sealed from the ambient. Furthermore, the push button has the effect to couple light towards the color sensor. For example, the push button material is arranged as a diffuser which directs light from various directions towards the color sensor. This implementation can be considered a direct coupling design of color sensor to the cap.

FIG. 2E shows another embodiment where the color sensor is integrated into a cavity 105. In this implementation, however, the push button 112 comprises the cavity 105 and is connected to the end section 104. The push button may be composed of an opaque material, e.g. be composed of metal, plastic, glass, or other suitable material. The push button further comprises a funnel 107 which, via its base 108, is connected to the cavity 105. An arc 109 of optically translucent material is arranged in the aperture 109 of the funnel. The arc 109 constitutes an optical window which allows light to enter the funnel and be directed towards the color sensor. For example, the arc material is arranged as a diffuser which directs light from various directions towards the color sensor.

FIG. 2F shows an embodiment where the color sensor is integrated into the cavity 105 of the end section 104. Similar to the embodiment of FIG. 2C, the push button is connected to the end section 104 and a light guide 110 is arranged in the end section and connects the cavity with the push button. However, the light guide 110 extends further from the opening 110 of the light guide into the push button. The color sensor 200, arranged in the cavity 105, is sealed from the ambient. The push button comprises an optically translucent material. The push button has the effect to couple light towards the color sensor via the light guide. For example, the push button material is arranged as a diffuser which directs light from various directions towards the color sensor. This implementation can be considered an indirect coupling design of color sensor to the cap.

The writing utensil, or pen, can be used for various applications. One example relates to determining a lightning condition. In general, the writing utensil can be a standalone device and conduct the steps necessary to determine a lightning condition all by itself, e.g. by means of the processing unit.

However, the pen may be considered part of an image-sensing device, which includes another device, such as a receiver to receive data from the pen, via network connection. In this case the pen does not necessarily have to perform all steps “on-device” but may rely on some or all steps being performed “off-device” by the other components of image-sensing device. Thus, the terms “processing unit” and “receiver processing unit” may be used interchangeably. The following will discuss examples, which may be considered representing possible applications but should not be seen as restricting the proposed concept in any way.

In one example, the pen is directed to a light source. For example, the end section with the color sensor is directed to the light source so that light from the source can enter. Then the color sensor generates sensor data which is indicative of the light emitted by the light source. The color sensor is implemented as a multispectral sensor so that the sensor data comprises spectral data of the detected light. Said spectral data is transmitted via the networking device to the receiver by activating switch 103, e.g. pressing a side button of the pen. The receiver is operable to receive the sensor data and forward the data to a receiver processing unit, e.g. a microcontroller, processor or CPU of the receiver. The receiver processing unit processes the sensor data and is operable to determine spectra from the data, perform calculations on the data, e.g. to determine correlated color temperature, CCT, color rendering index, CRI), and/or a type of the light source, e.g. by comparing spectra to known spectra of an internal or remote database. The receiver processing unit may also be operable to display or visualize the data and/or results of performed calculations on a display of the image-sensing device, or receiver.

In another example, the pen is used for controlling of multicolor LED light sources. The method may use the steps discussed in the foregoing paragraph. The processing unit may perform some different processing steps. The processing unit determines spectra from the received sensor signal. The spectra are compared with known spectra of known LEDs using an internal or remote database. The processing unit determines control parameters from said comparison. These control parameters are then used to adjust the multicolor LED light source. For example, the control parameters affect brightness and/or mixing of colors to match a desired color output, etc.

In another example, the method determining a lightning condition is continuously repeated, e.g. until terminated by user interaction or until a loop counter receives a pre-determined limit. Each cycle of the method may be associated with respective sensor data, e.g. a corresponding spectrum. In addition, the pen may be moved, e.g. to point into a different direction. Thus, sensor data and a corresponding spectra may be associated with the position and direction of the pen. For this the pen comprises an acceleration sensor and/or a rotation sensor which provide position and direction data. The sensor data of the color sensor is provided, and transmitted, together with the corresponding position and direction data. This way the method determining a lightning condition can be used create a multi-dimensional radiation map. The receiver processing unit may also be operable to display or visualize the multi-dimensional radiation map on a display of the image-sensing device, or receiver.

Another example embodiment relates to an image-sensing device. The image-sensing device comprises a pen 100, e.g. according to an embodiment discussed above, and a receiver. For example, the receiver is comprised by a host system such as a mobile phone, a camera, an image-recording device and/or a video recording device. The host system comprises at least one image sensor. The pen can be used to determine a color balance, such as white balance, for the at least one image sensor. Color balance can be considered a global adjustment of intensities of the colors, e.g. red, green, and blue, or other primary colors. Using the pen instead, or in addition, of the host system allows for determining light conditions at the location of the image scene.

The method for determining a light condition comprises placing the pen at an image scene. Then the color sensor generates sensor data which is indicative of the light illuminating the image scene. Generating the sensor data may be initiated by user interaction, e.g. by activating switch 103 of the pen. For example, the color sensor is implemented as a multispectral sensor so that the sensor data comprises spectral data of the detected light.

Said spectral data is transmitted via the networking device to the receiver by activating switch 103 again, e.g. pressing a side button of the pen. The receiver receives the sensor data and forwards the data to a receiver processing unit, e.g. a microcontroller, processor or CPU of the host system. The processing unit of the host system processes the sensor data. This involves a comparison of predefined spectral data to sensor data corresponding to an output of the color sensor. The comparison is indicative of an ambient light source classification, such as a correlated color temperature, CCT, color rendering index, CRI), and/or a type of the light source. The predefined spectral data may be accessed in an internal or remote database. The receiver processing unit may also be operable to display or visualize the data and/or results of performed calculations on a display of the image-sensing device, or receiver. The pen may further be arranged to trigger taking an image using the image sensor of the host system, e.g. by activating switch 103 again.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, various modifications may be made without departing from the spirit and scope of the invention. Accordingly, other implementations are within the scope of the claims.

1. A writing utensil, comprising:
a color sensor operable to generate sensor data,
a processing unit configured to receive the sensor data from the color sensor and to output the sensor data, and
a networking device configured to receive the sensor data from the processing unit and arranged to transmit the sensor data via a network connection, and
a switch, wherein the writing utensil is operable to:
generate the sensor data initiated by user interaction by activating the switch,
transmit the sensor data via the networking device to a receiver by activating the switch again, and
trigger taking an image by means of the imaging device by activating the switch again.

2. The writing utensil according to claim 1, wherein the color sensor comprises:
a multispectral sensor, and/or
an ambient light sensor.

3. The writing utensil according to claim 1, wherein the processing unit is configured to determine a light condition based on a comparison of predefined spectral data to sensor data corresponding to an output of the color sensor.

4. The writing utensil according to claim 3, wherein the light condition involves:
an ambient light source classification for adjusting a color balance,
a correlated color temperature, CCT,
a color rendering index, CRI,
a type of light source, and/or
an output of a multi-color light source such as a LED.

5. The writing utensil according to claim 1, wherein:
the writing utensil comprises a handheld housing and
the color sensor is arranged at an end section of the handheld housing.

6. The writing utensil according to claim 5, wherein
the end section comprises a cavity, and
the color sensor is arranged in the cavity.

7. The writing utensil according to claim 5, wherein
a push button is connected to the end section, and
the color sensor is arranged in a cavity of the end section or in a cavity of the push button.

8. (canceled)

9. A light detection system, comprising:
a writing utensil, and
an imaging device comprising a receiver operable to receive sensor data to be transmitted by the networking device, wherein the writing utensil comprises:
a color sensor operable to generate sensor data,
a processing unit configured to receive the sensor data from the color sensor and to output the sensor data,
a networking device configured to receive the sensor data from the processing unit and arranged to transmit the sensor data via a network connection, and
a switch, wherein the writing utensil is operable to:
generate the sensor data initiated by user interaction by activating the switch,
transmit the sensor data via the networking device to the receiver by activating the switch again, and
trigger taking an image by means of the imaging device by activating the switch again.

10. A method for determining a light condition, comprising:
generating sensor data using a color sensor arranged in a writing utensil,
processing the sensor data by means of a processing unit, and
transmitting the sensor data via a network to a receiver by means of a networking device.
